(19) United States
(12) Patent Application Publication
(10) Pub. No.: US 2009/0086824 A1
(43) Pub. Date: Apr. 2, 2009

(54) Video Decoding Apparatus and Systems

(75) Inventor: Kung-Sheng Lin, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 11/863,760

(22) Filed: Sep. 28, 2007

(51) Int. Cl. H04N 7/12

(52) U.S. Cl. 375/240.25; 375/E07.146

(57) ABSTRACT

A video decoding apparatus for processing a video bitstream is provided. The video decoding apparatus includes a plurality of decoders. Each decoder, except for the first decoder of the plurality of decoders is configured to decode a part of the video bitstream according to the previous decoding result of a preceding decoder. Thus, the video decoding apparatus can continuously process the video bitstream. The plurality of decoders can be configured to decode different parts of the video bitstream.

### CROSS-REFERENCES TO RELATED APPLICATIONS

This application is co-pending with the application entitled “APPARATUS AND METHOD FOR DECODING MULTIMEDIA CONTENT ACCORDING TO A CONTROL SIGNAL AND SYSTEM” filed on the same date by the same inventor of this invention.

### BACKGROUND OF THE INVENTION

1. Field of the Invention

The present invention relates to a video decoding apparatus and a system for processing a video bitstream. More particularly, the present invention relates to a video decoding apparatus and a system for processing a video bitstream by a plurality of decoders with each decoder decoding different parts of the video bitstream.

2. Descriptions of the Related Art

Multimedia data playback systems are commonly used around the world. Today, a playback system on the market decodes multimedia data into video presentation by using a video decoding apparatus. When decoding multimedia data, the video decoding apparatus decodes one video bitstream at a time. The video decoding apparatus decodes the next video bitstream after the former one has been decoded. This, however, increases processing time since the next video bitstream can only be buffered but not processed. Discontinuity of decoding also causes rugged processing of the video bitstream.

Since the video decoding apparatus decode one video bitstream at a time, it can only be applied in a particular multimedia data playback system. As a result, the video processing product supplier has to design different video decoding apparatuses conforming to different requirements of different playback systems.

Thus, it is advantageous to obtain a video decoding apparatus capable of continuously decoding video bitstreams and modulating the arrangement of decoders for different decoding requirements.

### SUMMARY OF THE INVENTION

The primary objective of this invention is to provide a video decoding apparatus for decoding a video bitstream to generate decoded video data by using at least two decoders with each decoder decoding different part of the video bitstream. The video bitstream has a plurality of different layer headers and at least one macroblock. The video decoding apparatus also comprises a memory for receiving and storing the video bitstream.

To achieve the objective, the decoders are configured to decode different parts of the video bitstream according to different decoding requirements. According to the hierarchical structure of the video bitstream, each decoder, except for the first decoder, is configured to decode a part of the video bitstream according to a previous decoding result of a preceding decoder. A last decoder of the decoders generates the decoded video data. Thus, the video decoding apparatus can continuously process the video bitstream.

Another objective of this invention is to provide a video decoding apparatus that can modulate the arrangement of decoders for different decoding requirements. Different playback systems may require different arrangements of the hierarchical structure of the video bitstream, and thus, the plurality of decoders provided by the present invention can be configured to decode different parts of the video bitstream by each decoder.

Another objective of this invention is to provide a playback system. The playback system may be a home theater, a multimedia data playback system, a portable multimedia data playback system, a DVD player, a television, or something alike. The playback system comprises a receiver and a video decoding apparatus. The receiver is configured to receive a video bitstream having a sequence header, a GOP header, a picture header, a slice header, and at least one macroblock, while the video decoding apparatus is configured to decode the video bitstream by at least two decoders.

Further, another video decoding method for decoding a video bitstream to generate decoded video data is provided wherein the video bitstream includes a plurality of different layer headers and at least one macroblock is provided. The video bitstream is received and a part of the video bitstream is decoded accordingly to generate a decoding result. A remaining part of the video bitstream is then decoded according to the decoding result to generate the decoded video data.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating the hierarchical structure of a video bitstream;

FIG. 2 is a preferred embodiment of a video decoding apparatus of the invention;

FIG. 3 is another preferred embodiment of a video decoding apparatus of the invention;

FIG. 4 is yet another preferred embodiment of a video decoding apparatus of the invention;

FIG. 5 is a further preferred embodiment of a video decoding apparatus of the invention; and

FIG. 6 is yet a further preferred embodiment of a video decoding apparatus of the invention.

### DESCRIPTION OF THE PREFERRED EMBODIMENT

In the descriptions that follow, the present invention will be described in reference to embodiments that decode a video bitstream using a plurality of decoders. However, embodiments of the invention are not limited to any particular environment, application or implementation. Therefore, the descriptions of the embodiments that follow are for purposes of illustration and not limitation.

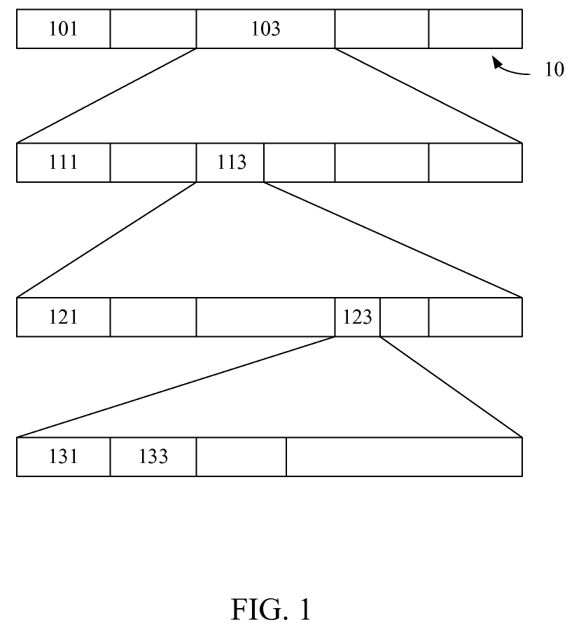

FIG. 1 illustrates the concept of the hierarchical structure of a video bitstream. The video bitstream comprises the following layers: video sequence, a group of pictures (GOP), picture, slices, and macroblock. Each former layer comprises the latter with a header. For example, as shown in FIG. 1, a video sequence 10 comprises a video sequence header 101 and at least one GOP 103. Similarly, the GOP 103 comprises a GOP header 111 and at least one picture 113, while the picture 113 comprises a picture header 121 and at least one slice 123. Likewise, the slice 123 comprises a slice header 131 and at least one macroblock 133. As a result, the video bitstream can be realized as having a sequence header, a GOP header, a picture header, a slice header, and at least one macroblock. Macroblock which generally comprises 16×16 pixels is the basis of the video bitstream; that is a number of macroblocks form at least one of a macroblock, a slice, and a picture of the multimedia data.

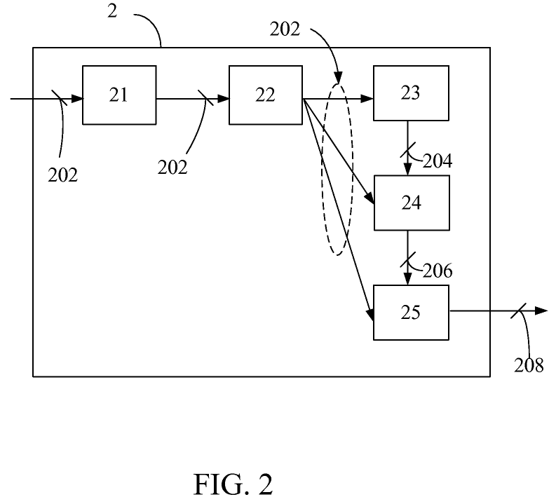

FIG. 2 illustrates a preferred embodiment of the invention, which is a video decoding apparatus 2 for decoding a video bitstream 202. The video bitstream 202 conforms to the hierarchical structure shown in FIG. 1, that is, the video bitstream 202 comprises a sequence header, a GOP header, a picture header, a slice header, and at least one macroblock. The video decoding apparatus 2 comprises a memory buffer 21, a data buffer 22, a first decoder 23, a second decoder 24, and a third decoder 25. The memory buffer 21 is configured to temporarily store the video bitstream 202 upon receipt of the video bitstream 202. The data buffer 22 is configured to receive the video bitstream 202 from the memory buffer 21. The first decoder 23, second decoder 24, and third decoder 25 retrieve the video bitstream 202 from the data buffer 22 (i.e. from the memory buffer 21 indirectly) to decode the video bitstream 202. It is noted that the first decoder 23, second decoder 24, and third decoder 25 may retrieve the video bitstream 202 directly from the memory buffer 21 in other embodiments. In other words, the video decoding apparatus in other embodiments may not comprise the data buffer 22.

The video bitstream 202 is decoded in the following order: first, the sequence header, followed by the GOP header, the picture header, the slice header, and lastly, the at least one macroblock. The first decoder 23 is configured to decode a first part of the video bitstream 202, comprising the sequence header, the GOP header, and a part of the picture header retrieved from the data buffer 22 (i.e. from the memory buffer 21 indirectly) to generate a first decoding result 204. It is assumed that the part of the picture header is a half of the picture header. The second decoder 24 then decodes a second part of the video bitstream 202 retrieved from the data buffer 22 (i.e. from the memory buffer 21 indirectly) according to the first decoding result 204, wherein the second part of the video bitstream 202 comprises the remaining part (i.e. another half) of the picture header and the slice header. To be more specific, the first decoding result 204 indicates that the first part of the video bitstream 202 has been decoded by the first decoder 23, so the second decoder 24 is able to decode the second part of the video bitstream 202 to generate a second decoding result 206. The second decoding result 206 indicates that the first and second parts of the video bitstream 202 have been decoded by the second decoder 24. The third decoder 25 decodes a remaining part of the video bitstream 202 retrieved from the data buffer 22 (i.e. from the memory 21 indirectly) according to the second decoding result 206 and generates a decoded video data 208. With the arrangement of FIG. 2, the first decoder 23 can decode a next video bitstream when the second decoder 24 decodes the second part of the video bitstream 202. Similarly, when the third decoder 25 decodes the remaining part of the video bitstream 202 according to the second decoding result 206, the second decoder 24 can decode the next video bitstream according to a first decoding result of the next video bitstream from the first decoder 23. That is, the video bitstream 202 can be divided into many parts and separately decoded. Since the first decoder 23, the second decoder 24, and the third decoder 25 can decode different parts of video bitstreams 202 at the same time, processing time of the video decoding apparatus 2 is reduced.

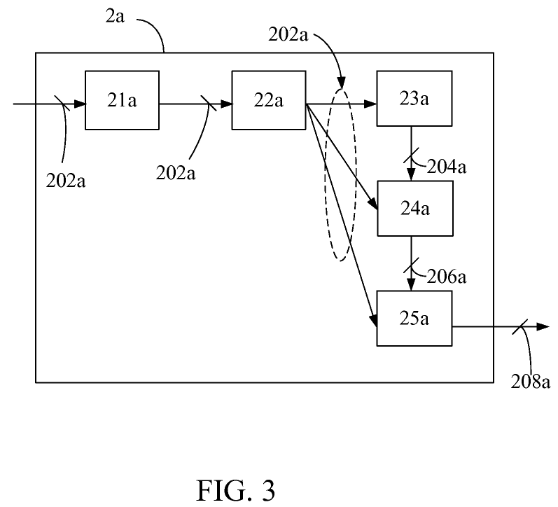

FIG. 3 illustrates another preferred embodiment of the invention, which is a video decoding apparatus 2a for decoding a video bitstream 202a. The video bitstream 202a conforms to the hierarchical structure shown in FIG. 1, that is, the video bitstream 202a comprises a sequence header, a GOP header, a picture header, a slice header, and at least one macroblock. The video decoding apparatus 2a comprises a memory buffer 21a, a data buffer 22a, a first decoder 23a, a second decoder 24a, and a third decoder 25a.

Referring to the embodiment illustrated in FIG. 2, the substantially difference is that the first decoder 23a is configured to decode a first part of the video bitstream 202a, comprising the sequence header, the GOP header, and the picture header retrieved from the data buffer 22a (i.e. from the memory buffer 21a indirectly) to generate a first decoding result 204a. The second decoder 24a then decodes a second part of the video bitstream 202a retrieved from the data buffer 22a (i.e. from the memory buffer 21 indirectly) according to the first decoding result 204a, wherein the second part of the video bitstream 202a comprises the slice header. Then the second decoder 24a generates a second decoding result 206a.

The third decoder 25a decodes a remaining part of the video bitstream 202a retrieved from the data buffer 22a (i.e. from the memory 21a indirectly) according to the second decoding result 206a and generates a decoded video data 208a.

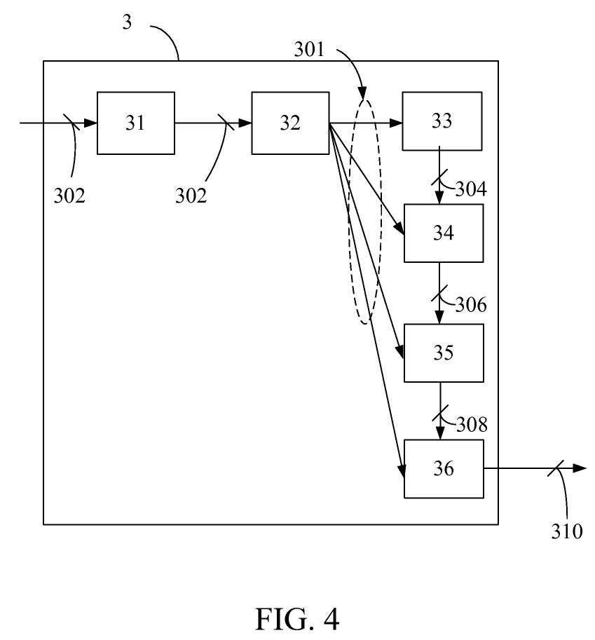

FIG. 4 illustrates another preferred embodiment of the present invention, which is a video decoding apparatus 3 for decoding a video bitstream 302, wherein the video bitstream 302 comprises a sequence header, a GOP header, a picture header, a slice header, and at least one macroblock. The video decoding apparatus 3 comprises a memory buffer 31, a data buffer 32, a first decoder 33, a second decoder 34, a third decoder 35, and a fourth decoder 36. The memory buffer 31 temporarily stores the video bitstream 302. The memory buffer 31 and the data buffer 32 are substantially the same as the memory buffer 21 and the data buffer 22. The order in which the video bitstream 302 is decoded is the same as the decoding order of the video bitstream 202. Therefore, the redundant descriptions are omitted.

The first decoder 33 is configured to decode the sequence header and the GOP header, wherein both of them are retrieved from the data buffer 32 (i.e. from the memory buffer 31 indirectly). The first decoder 33 generates a first decoding result 304 upon decoding. The second decoder 34 then decodes the picture header retrieved from the data buffer 32 (i.e. from the memory buffer 31 indirectly) according to the first decoding result 304. The decoding result 304 indicates the sequence header and the GOP header of the video bitstream 302 have been decoded by the first decoder 33 so that the second decoder 34 is able to decode the picture header after the sequence header and the GOP header. The second decoder 34 then generates a second decoding result 306 indicating that the picture header of the video bitstream 302 has been decoded. The third decoder 35 decodes the slice header of the video bitstream 302 retrieved from the data buffer 32 (i.e. from the memory buffer 31 indirectly) according to the second decoding result 306 to generate a third decoding result 308. Then, the fourth decoder 36 decodes at least one macroblock of the video bitstream 302 according to the third decoding result 308 and generates a decoded video data 310. The video bitstream 302 is completely decoded after being processed by the fourth decoder 36.

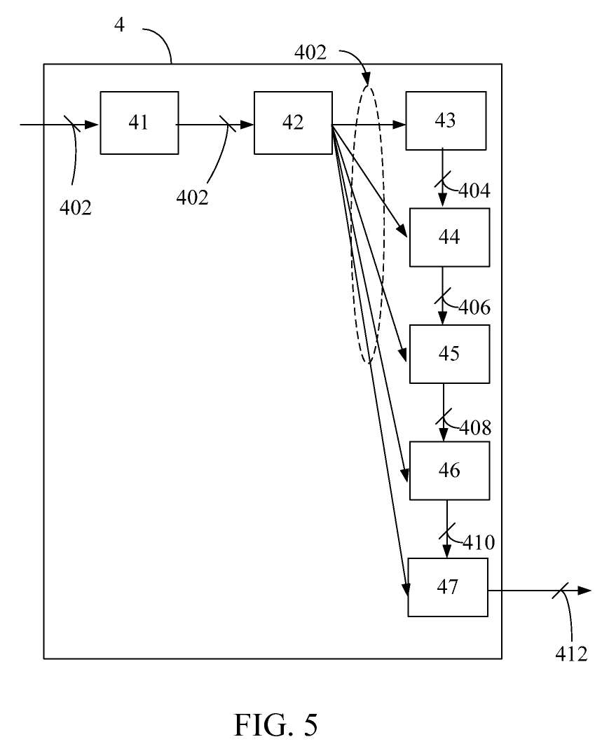

FIG. 5 illustrates a further preferred embodiment of a video decoding apparatus 4 of the present invention for decoding a video bitstream 402, wherein the video bitstream 402 comprises a sequence header, a GOP header, a picture header, a slice header, and at least one macroblock. The video decoding apparatus 4 comprises a memory buffer 41, a data buffer 42, a first decoder 43, a second decoder 44, a third decoder 45, a fourth decoder 46, and a fifth decoder 47. The decoders 43, 44, 45, 46, and 47 are configured to decode different parts of the video bitstream 402. The memory buffer 41 temporarily stores the video bitstream 402. The memory buffer 41 and the data buffer 42 are relatively similar to the memory buffer 21 and the data buffer 22. The order in which the video bitstream 402 is decoded is the same as the decoding order of the video bitstream 202. Therefore, the redundant descriptions are omitted.

The first decoder 43 is configured to decode the sequence header retrieved from the data buffer 42 (i.e. from the memory buffer 41 indirectly) to generate a first decoding result 404. The second decoder 44 then decodes the GOP header retrieved from the data buffer 42 (i.e. from the memory buffer 41 indirectly) according to the first decoding result 404. The first decoding result 404 indicates that the sequence header has been decoded by the first decoder 43 so that the second decoder 44 is able to decode the GOP header accordingly. The second decoder 44 then generates a second decoding result 406 indicating that the GOP header of the video bitstream 402 has been decoded by the second decoder 44. The third decoder 45 decodes the picture header of the video bitstream 402 retrieved from the data buffer 42 (i.e. from the memory buffer 41 indirectly) according to the second decoding result 406 to generate a third decoding result 408. Then, the fourth decoder 46 decodes the slice header of the video bitstream 402 according to the third decoding result to generate a fourth decoding result 410. The fifth decoder 47 then decodes at least one macroblock of the video bitstream 402 according to the fourth decoding result 410 and generates a decoded video data 412. The video bitstream 402 is completely decoded after being processed by the fifth decoder 47.

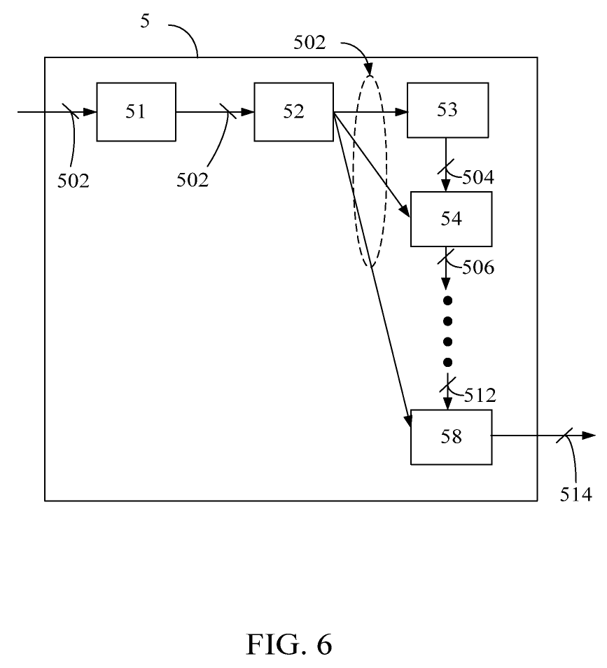

FIG. 6 illustrates yet a further preferred embodiment of a video decoding apparatus 5 of the present invention for decoding a video bitstream 502, wherein the video bitstream comprises a sequence header, a GOP header, a picture header, a slice header, and at least one macroblock. The video decoding apparatus 5 comprises a memory buffer 51, a data buffer 52, and a plurality of decoders 53, 54 . . . 58. FIG. 5 illustratively denotes the first decoder 53, the second decoder 54, and the last decoder 58. The decoders shown in FIG. 5 are configured to decode different parts of a video bitstream 502. The memory buffer 51 temporarily stores the video bitstream 502. The memory buffer 51 and the data buffer 52 are relatively similar to the memory buffer 21 and the data buffer 22. The order in which the video bitstream is decoded 502 is the same as the decoding order of the video bitstream 202. Therefore, the redundant descriptions are omitted.

The first decoder 53 is configured to decode a first part of the video bitstream 502 retrieved from the data buffer 52 (i.e. from the memory buffer 51 indirectly). To be more specific, the first part decoded by the first decoder 53 comprises at least a part of the sequence header of the video bitstream 502. Upon the decoding, the first decoder 53 generates a first decoding result 504 that indicates the parts of the video bitstream 502 that have been decoded by the first decoder 53. The second decoder 54 next to the first decoder 53 decodes a second part of the video bitstream 502 according to the first decoding result 504. For example, the first decoder 53 may only decode a part of the sequence header, then the second decoder 54 may be configured to decode (1) the rest of the sequence header, (2) another part of the sequence header, or (3) the rest of the sequence header and a part of the rest video bitstream 502 according to the first decoding result 504 and the configuration of the video decoding apparatus 5. Upon the decoding, the second decoder 54 generates a second decoding result 506 for the next decoder. By the same principle, each decoder, except for the first decoder 53 is configured to decode a part of the video bitstream 502 according to the former decoding result. The last decoder, denoted as the decoder 58 in FIG. 5, is configured to decode the at least one macroblock according to the decoding result 512 of the former decoder, since that macroblock is the basis of the video bitstream 502, and generate a decoded video data 514. The video bitstream 502 is completely decoded after being processed by the last decoder 58.

The aforementioned embodiments can be applied to many kinds of systems, such as home theaters, multimedia playback systems, portable multimedia playback systems, televisions, DVD players, etc. A system equipped with an aforementioned video decoding apparatus may be equipped with a receiver as well. The receiver is configured to receive a video bitstream having a sequence header, a GOP header, a picture header, a slice header, and at least one macroblock. Upon the receiving of the video bitstream, the video decoding apparatus can then perform the processing/decoding.

According to the aforementioned description, the present invention can decode a video bitstream using multiple decoders. By decoding different parts of the video bitstream in different decoders, the video decoding apparatus can continuously process video bitstreams without waiting for a former one to finish decoding. The video decoding apparatus can also modulate the arrangement of the decoders for different decoding requirements. Therefore, the present invention can reduce the time it takes to decode a video bitstream and can be adapted to fit different decoding requirements.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A video decoding apparatus for decoding a video bitstream having a plurality of different layer headers and at least one macroblock to generate decoded video data, the video decoding apparatus comprising:
a memory for receiving and storing the video bitstream; and
at least two decoders coupled in series and to the memory, each decoding different parts of the video bitstream, wherein one of the decoders decodes a part of the video bitstream according to a previous decoding result of a preceding decoder and a last decoder of the decoders generates the decoded video data.

2. The video decoding apparatus as claimed in claim 1, wherein each of the decoders decodes one of the different layer headers and the last decoder decodes a remaining part of the video bitstream.

3. The video decoding apparatus as claimed in claim 1, wherein the different layer headers comprise a sequence header, a group of pictures (GOP) header, a picture header, and a slice header.

4. The video decoding apparatus as claimed in claim 3, wherein the sequence header, the GOP header, the picture header, the slice header, and the at least one macroblock are processed in order.

5. The video decoding apparatus as claimed in claim 3, comprising:
a first decoder coupled to the memory, decoding the sequence header, the GOP header, and a part of the picture header of the video bitstream from the memory and generating a first decoding result;
a second decoder coupled to the memory and first decoder, decoding a remaining part of the picture header and the slice header of the video bitstream from the memory according to the first decoding result and generating a second decoding result; and
a third decoder coupled to the memory and second decoder, decoding the at least one macroblock of the bitstream from the memory according to the second decoding result and generating the decoded video data.

6. The video decoding apparatus as claimed in claim 3, comprising:
a first decoder coupled to the memory, decoding the sequence header, the GOP header, and the picture header of the video bitstream from the memory and generating a first decoding result;
a second decoder coupled to the memory and the first decoder, decoding the slice header of the video bitstream from the memory according to the first decoding result and generating a second decoding result; and
a third decoder coupled to the memory and the second decoder, decoding the at least one macroblock of the video bitstream from the memory according to the second decoding result and generating the decoded video data.

7. The video decoding apparatus as claimed in claim 3, comprising:
a first decoder coupled to the memory, decoding the sequence header and the GOP header of the video bitstream from the memory and generating a first decoding result;
a second decoder coupled to the memory and the first decoder, decoding the picture header of the video bitstream from the memory according to the first decoding result and generating a second decoding result;
a third decoder coupled to the memory and the second decoder, decoding the slice header of the video bitstream from the memory according to the second decoding result and generating a third decoding result; and
a fourth decoder coupled to the memory and the third decoder, decoding the at least one macroblock of the video bitstream from the memory according to the third decoding result and generating the decoded video data.

8. The video decoding apparatus as claimed in claim 3, comprising:
a first decoder coupled to the memory, decoding the sequence header of the video bitstream from the memory and generating a first decoding result;
a second decoder coupled to the memory and the first decoder, decoding the GOP header of the video bitstream from the memory according to the first decoding result and generating a second decoding result;
a third decoder coupled to the memory and the second decoder, decoding the picture header of the video bitstream from the memory according to the second decoding result and generating a third decoding result;
a fourth decoder coupled to the memory and the third decoder, decoding the slice header of the video bitstream from the memory according to the third decoding resultand generating a fourth decoding result; and
a fifth decoder coupled to the memory and the fourth decoder, decoding the at least one macroblock of the video bitstream from the memory according to the fourth decoding result and generating the decoded video data.

9. A playback system, comprising:
a receiver for receiving a video bitstream having a plurality of different layer headers and at least one macroblock; and
a video decoding apparatus for decoding the video bitstream to generate decoded video data, the video decoding apparatus comprising:
a memory for receiving and storing the video bitstream; and
at least two decoders coupled in series and to the memory, each decoding different parts of the video bitstream, wherein one of the decoders decodes a part of the video bitstream according to a previous decoding result of a preceding decoder and a last decoder of the decoders generates the decoded video data.

10. The playback system as claimed in claim 9, wherein each of the decoders decodes one of the different layer headers and the last decoder decodes a remaining part of the video bitstream.

11. The playback system as claimed in claim 9, wherein the different layer headers comprise a sequence header, a group of pictures (GOP) header, a picture header, and a slice header.

12. The playback system as claimed in claim 11, wherein the sequence header, the GOP header, the picture header, the slice header, and the at least one macroblock are processed in order.

13. The playback system as claimed in claim 9, wherein the playback system is one of a multimedia data playback system, a portable multimedia data playback system, a DVD player, a home theater, and a television.

14. A video decoding method for decoding a video bitstream comprising a plurality of different layer headers and at least one macroblock, the video decoding apparatus comprising:
receiving the video bitstream;
decoding a part of the video bitstream to generate a decoding result; and
decoding a remaining part of the video bitstream according to the decoding result to generate decoded video data.

15. The video decoding method as claimed in claim 14, wherein the step of decoding a part of the video bitstream comprises decoding one of the different layer headers.

16. The video decoding method as claimed in claim 14, wherein the step of receiving the video bitstream comprises receiving a sequence header, a group of pictures (GOP) header, a picture header, and a slice header of the video bitstream.

17. The video decoding method as claimed in claim 16, wherein the steps of decoding a part of the video bitstream and decoding a remaining part of the video bitstream are executed to process the sequence header, the GOP header, the picture header, the slice header, and the at least one macroblock in order.

18. The video decoding method as claimed in claim 16, wherein the step of decoding a remaining part of the video bitstream comprises decoding the at least one macroblock.
